(19) United States
(12) Patent Application Publication
(10) Pub. No.: US 2025/0172185 A1
(43) Pub. Date: May 29, 2025

(54) Vibration reduction in refrigerant pipes of an HVAC system using a tuned mass damper

(71) Applicant: Lennox Industries Inc., Richardson, TX (US)

(72) Inventors: Aditya Prasad Botla, East Godavari (IN); Tejasree Kongara, Eluru District (IN); Yuvaraj Palanisamy, Tiruppur (IN); Eric Christopher Berg, The Colony, TX (US)

(21) Appl. No.: 18/521,775

(22) Filed: Nov. 28, 2023

(51) Int. Cl. F16F 7/108; F24F 1/40

(52) U.S. Cl. CPC F16F 7/108; F24F 1/40; F16F 2222/08; F16F 2224/025; F16F 2226/042; F16F 2230/0005

(57) ABSTRACT

A damper is attached to a refrigerant pipe of a heating, ventilation, and air conditioning (HVAC) system at a first location. The damper includes a first annular structure including an elastic material. The refrigerant pipe extends through the first annular structure. The damper further includes a clamp configured to secure the first annular structure at the first location of the refrigerant pipe. The clamp includes a metallic material and one or more tightening mechanisms configured to secure the clamp at the first location of the refrigerant pipe.

### TECHNICAL FIELD

The present disclosure relates generally to Heating, Ventilation, and Air Conditioning (HVAC) system control, and more specifically to a system and method for vibration reduction in refrigerant pipes of an HVAC system using a tuned mass damper.

### BACKGROUND

Vibrations in refrigerant pipes is a reliability/durability concern in the heating, ventilation, and air conditioning (HVAC) industry. Current methods for vibration reduction include routing changes of refrigerant pipes, isolation of refrigerant pipes from a vibration source (e.g., a compressor) and addition of support brackets to refrigerant pipes. These methods may be impractical since they may require a redesign of HVAC systems.

### SUMMARY

The system disclosed in the present application provides a technical solution to the technical problems discussed above by providing a system and method for vibration reduction in refrigerant pipes of an HVAC system using a tuned mass damper.

The present disclosure is directed to a mass damper, which allows for a solution to the refrigerant pipe vibration problem that requires no (or reduced) changes in the routing of refrigerant pipes, or addition of supports or source isolation devices such as flexible hoses and vibration eliminators. The mass damper is easy to install, and generally does not require any specialized tools or skills, making it suitable for repair, retrofit, and field-modification situations.

In general, a mass damper may be characterized by a mass, a spring constant, and a damping constant. The mass damper is attached to a desired location of a refrigerant pipe. The desired location may be a location of the refrigerant pipe with increased vibration amplitude or a location which allows for reduction of a stress that is exerted on the refrigerant pipe due to vibrations. The mass, the spring constant, and the damping constant of the mass damper may be determined by performing simulations (e.g., finite-element simulations) on the HVAC system. For example, the mass, the spring constant, and the damping constant may be determined by ensuring that the stress exerted on the refrigerant pipe during operation is reduced, which in turn reduces the vibration amplitude of the refrigerant pipe. The determined mass, spring constant, and damping constant are used to determine materials and geometry for various components of the mass damper.

In one embodiment, a damper is attached to a refrigerant pipe of a heating, ventilation, and air conditioning (HVAC) system at a first location. The damper includes a first annular structure including an elastic material. The refrigerant pipe extends through the first annular structure. The damper further includes a clamp configured to secure the first annular structure at the first location of the refrigerant pipe. The clamp includes a metallic material and one or more tightening mechanisms configured to secure the clamp at the first location of the refrigerant pipe.

In another embodiment, a damper is attached to a refrigerant pipe of a heating, ventilation, and air conditioning (HVAC) system at a first location. The damper includes a first annular structure. The first annular structure includes an elastic material. The elastic material has a hole therein and a cut extending from an inner sidewall of the elastic material to an outer sidewall of the elastic material. The refrigerant pipe extends through the hole. The damper further includes a clamp configured to secure the first annular structure at the first location of the refrigerant pipe. The clamp includes a metallic material and one or more tightening mechanisms configured to secure the clamp at the first location of the refrigerant pipe.

In yet another embodiment, a damper is attached to a refrigerant pipe of a heating, ventilation, and air conditioning (HVAC) system. The damper includes an annular elastic structure and an annular metallic structure embedded in the annular elastic structure. The refrigerant pipe extends through the annular elastic structure.

Certain embodiments of the present disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of an HVAC system;

FIG. 2 is a schematic diagram of an embodiment of a mass damper attached to a refrigerant pipe;

FIG. 3 is an equivalent representation of an embodiment of a mass damper attached to a refrigerant pipe;

FIG. 4 is a schematic diagram of an embodiment of a mass damper;

FIG. 5 is a schematic diagram of an embodiment of a mass damper;

FIG. 6 is a schematic diagram of an embodiment of a mass damper;

FIG. 7 is a schematic diagram of an embodiment of a mass damper;

FIG. 8 is a schematic diagram of an embodiment of a mass damper;

FIG. 9A is a schematic diagram of an embodiment of a mass damper;

FIG. 9B is a schematic diagram of an embodiment of an elastic strip with an embedded metallic strip;

FIG. 10A is a schematic diagram of an embodiment of a mass damper;

FIG. 10B is a schematic diagram of an embodiment of a pin;

FIG. 11 illustrates graphs of a simulated acceleration of a refrigerant pipe with or without an attached mass damper; and

FIG. 12 illustrates graphs of a measured acceleration of a refrigerant pipe with or without an attached mass damper.

### DETAILED DESCRIPTION

### System Overview

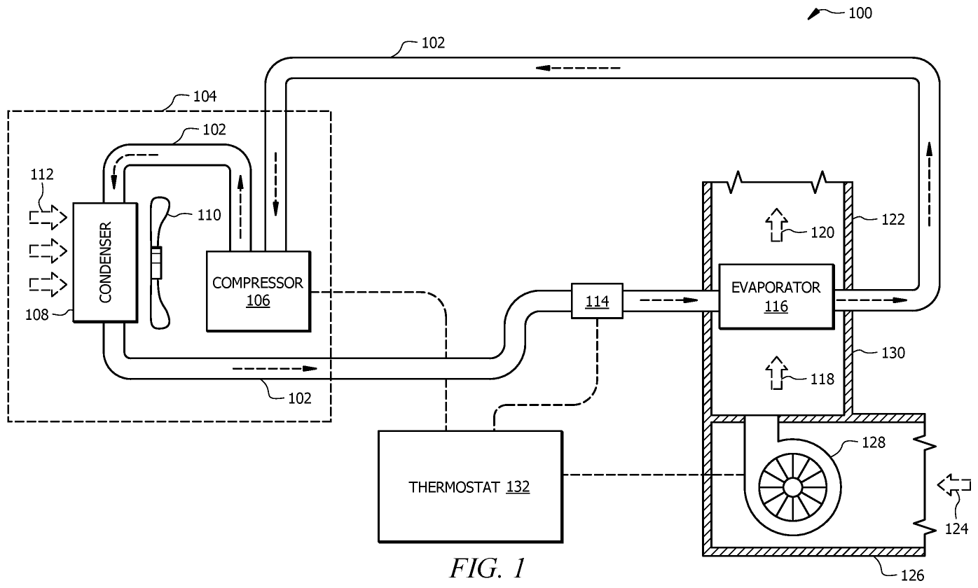

FIG. 1 is a schematic diagram of an embodiment of a heating, ventilation, and air conditioning (HVAC) system 100 operably coupled to a thermostat 132. In other embodiments, the HVAC system 100 and the thermostat 132 may not have all the components listed and/or may have other elements instead of, or in addition to, those listed above.

### System Components

### HVAC System

An HVAC system 100 is generally configured to control the temperature of a space. Examples of the space include, but are not limited to, a room, a home, an apartment, a mall, an office, a warehouse, or a building. Although FIG. 1 illustrates a single HVAC system 100, a location or space may comprise a plurality of HVAC systems that are configured to work together. For example, a large building may comprise multiple HVAC systems that work cooperatively to control the temperature within the building.

The HVAC system 100 conditions air for delivery to a conditioned space (e.g., all or a portion of a room, a house, an office building, a warehouse, or the like). In certain embodiments, the HVAC system 100 is a rooftop unit (RTU) that is positioned on the roof of a building, and the conditioned air is delivered to the interior of the building. In other embodiments, portion(s) of the HVAC system 100 may be located within the building and portion(s) outside the building. The HVAC system 100 may include one or more heating elements, not shown for convenience and clarity. The HVAC system 100 may be configured as shown in FIG. 1 or in any other suitable configuration. For example, the HVAC system 100 may include additional components or may omit one or more components shown in FIG. 1.

The HVAC system 100 includes a working-fluid conduit subsystem 102, at least one condensing unit 104, an expansion valve 114, an evaporator 116, and a blower 128.

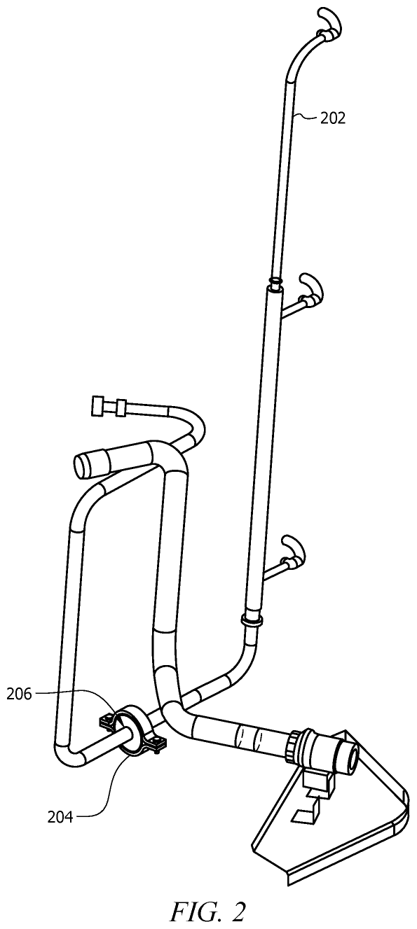

The working-fluid conduit subsystem 102 facilitates the movement of a working fluid (e.g., a refrigerant) through a cooling cycle such that the working fluid flows as illustrated by the dashed arrows in FIG. 1. The working fluid may be any acceptable working fluid including, but not limited to hydrofluorocarbons (e.g., R-410A) or any other suitable type of refrigerant. The working-fluid conduit subsystem 102 may comprise refrigerant pipes (e.g., refrigerant pipe 202 of FIG. 2). The refrigerant pipes may be made of a metallic material such copper, for example.

The condensing unit 104 includes a compressor 106, a condenser 108, and a fan 110. In some embodiments, the condensing unit 104 is an outdoor unit while other components of the HVAC system 100 may be located indoors. In typical embodiments, the compressor 106 is a variable speed compressor that can be operated at a range of speeds. The compressor 106 is coupled to the working-fluid conduit subsystem 102 and compresses (i.e., increases the pressure of) the working fluid.

The condenser 108 is configured to facilitate movement of the working fluid through the working-fluid conduit subsystem 102. The condenser 108 is generally located downstream of the compressor 106 and is configured to remove heat from the working fluid. The fan 110 is configured to move air 112 across the condenser 108. For example, the fan 110 may be configured to blow outside air through the condenser 108 to help cool the working fluid flowing therethrough. The compressed, cooled working fluid flows from the condenser 108 toward the expansion valve 114.

The expansion valve 114 is coupled to the working-fluid conduit subsystem 102 downstream of the condenser 108 and is configured to remove pressure from the working fluid. In this way, the working fluid is delivered to the evaporator 116. In general, the expansion valve 114 may be a valve such as an expansion valve or a flow control valve (e.g., a thermostatic expansion valve (TXV)) or any other suitable valve for removing pressure from the working fluid while, optionally, providing control of the rate of flow of the working fluid.

The evaporator 116 is generally any heat exchanger configured to provide heat transfer between air flowing through (or across) the evaporator 116 (i.e., airflow 118 contacting an outer surface of one or more coils of the evaporator 116) and working fluid passing through the interior of the evaporator 116. The evaporator 116 may include one or more circuits of coils. The evaporator 116 is fluidically connected to the compressor 106, such that working fluid generally flows from the evaporator 116 to the condensing unit 104 when the HVAC system 100 is operating to provide cooling.

The HVAC system 100 is configured to move airflow 118 provided by the blower 128 across the evaporator 116 and out of the duct sub-system 122 as conditioned airflow 120. Return air 124, which may be air returning from the building, fresh air from outside, or some combination, is pulled into a return duct 126. A suction side of the blower 128 pulls the return air 124. The blower 128 discharges airflow 118 into a duct 130 such that airflow 118 crosses the evaporator 116 or heating elements (not shown) to produce conditioned airflow 120. The blower 128 is any mechanism for providing airflow 118 through the HVAC system 100. For example, the blower 128 may be a constant speed or variable speed circulation blower or fan. Examples of a variable speed blower include, but are not limited to, belt-drive blowers controlled by inverters, direct-drive blowers with electronic commuted motors (ECM), or any other suitable type of blower.

The HVAC system 100 is in signal communication with one or more thermostats 132 using wired and/or wireless connection. The thermostat 132 may be located within a conditioned space (e.g., a room or building). The thermostat 132 may be a single-stage thermostat, a multi-stage thermostat, or any suitable type of thermostat as would be appreciated by one of ordinary skill in the art. The thermostat 132 is configured to allow a user to input a desired temperature or temperature set point for a designated space or zone such as the room.

### Mass Damper

FIG. 2 is a schematic diagram of an embodiment of a mass damper 204 attached to a refrigerant pipe 202. The refrigerant pipe 202 may be made of a metallic material such as copper, for example. The refrigerant pipe 202 may vibrate during operation of the HVAC system 100 or during transporting the HVAC system 100. During operation, the refrigerant pipe 202 may vibrate due the vibration of the compressor 106 (see FIG. 1). Vibrations in the refrigerant pipe 202 exert stress on the refrigerant pipe 202, which may damage the refrigerant pipe 202 and may cause a leakage of the refrigerant. The damper 204 is attached at a location 206 of the refrigerant pipe 202 and allows for reducing vibrations in the refrigerant pipe 202 at the location 206. This in turn allows for reducing the stress exerted on the refrigerant pipe 202. In certain embodiments, the location 206 may be a location of the refrigerant pipe 202 with increased vibration amplitude. In other embodiments, the location 206 may be a location of the refrigerant pipe 202, which allows for reduction of a stress that is exerted on the refrigerant pipe due to vibrations.

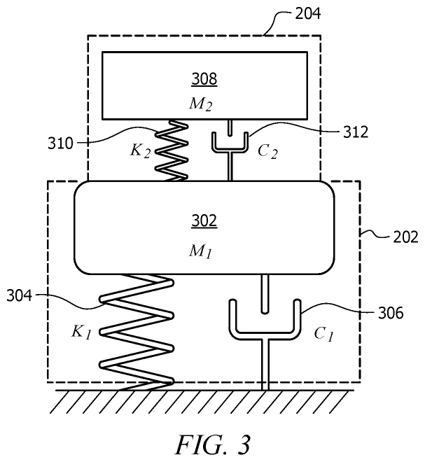

FIG. 3 illustrates an equivalent representation of the mass damper 204 attached to the refrigerant pipe 202 (see FIG. 2). The refrigerant pipe 202 may be represented by a mass element 302 having a mass M₁, a spring element 304 having a spring constant K₁, and a damper element 306 having a damping constant C₁. The mass damper 204 may be represented by a mass element 308 having a mass M₂, a spring element 310 having a spring constant K₂, and a damper element 312 having a damping constant C₂. As described below in greater detail, the mass M₂ of the mass element 308, the spring constant K₂ of the spring element 310 and the damping constant C₂ of the damper element 312 may be determined by performing computer simulations (e.g., finite-element simulations) on the HVAC system 100. For example, the mass M₂ of the mass element 308, the spring constant K₂ of the spring element 310 and the damping constant C₂ of the damper element 312 may be determined by ensuring that the stress exerted on the refrigerant pipe 202 during operation or transportation is reduced, which in turn reduces vibrations (e.g., vibration amplitude) in the refrigerant pipe 202. The mass M₂ of the mass element 308, the spring constant K₂ of the spring element 310 and the damping constant C₂ of the damper element 312 are used to determine materials and geometry (e.g., dimensions) for various components of the mass damper 204.

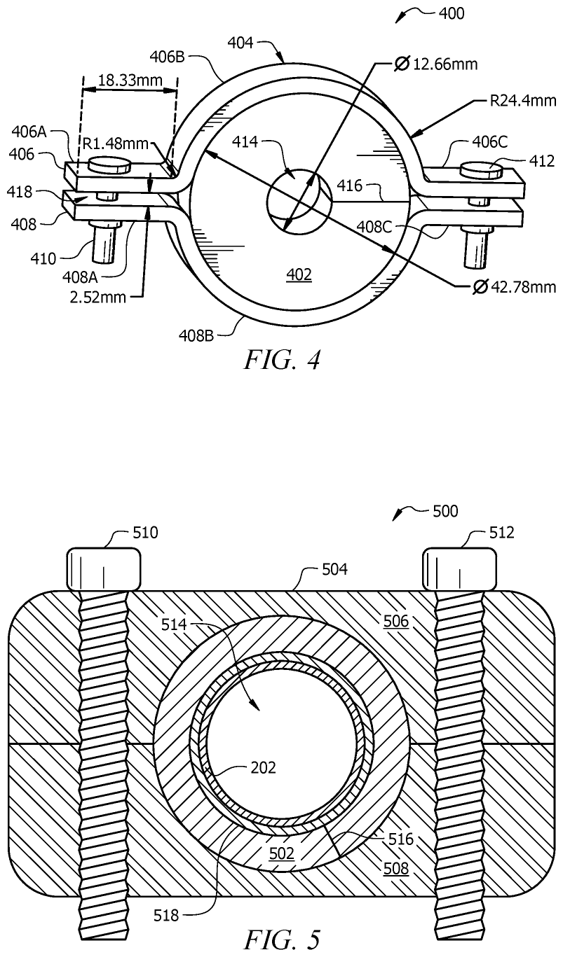

FIG. 4 is a schematic diagram of an embodiment of a mass damper 400. The mass damper 400 may comprise an annular structure 402 and a clamp 404. The clamp 404 is configured to secure the annular structure 402 at a desired location (e.g., location 206 of FIG. 2) of a refrigerant pipe (e.g., refrigerant pipe 202 of FIG. 2). The annular structure 402 is made of an elastic material. In certain embodiments, the elastic material may comprise nitrile rubber or the like. The annular structure 402 has a hole 414 and a cut 416 extending from an inner sidewall of the annular structure 402 to an outer sidewall of the annular structure 402. The annular structure 402 is attached to the refrigerant pipe (e.g., refrigerant pipe 202 of FIG. 2) such that the refrigerant pipe extends through the hole 414. The cut 416 of the annular structure 402 is configured to aid in placing the annular structure 402 at the desired location (e.g., location 206 of FIG. 2) of the refrigerant pipe (e.g., refrigerant pipe 202 of FIG. 2). For example, the cut 416 may be expanded to form a gap through which the refrigerant pipe may be inserted into the annular structure 402. In one embodiment, the hole 414 has a diameter of 12.66 mm. In the illustrated embodiment, the annular structure 402 has a shape of a cylindrical shell. In other embodiments, the annular structure 402 may have any desired annular shape depending on technical requirements of the mass damper 400. In one embodiment, the annular structure 402 has an outer diameter of 42.78 mm.

The clamp 404 may be made of a metallic material. The metallic material may comprise copper, aluminum, stainless steel, an alloy thereof, a combination thereof, or the like. In certain embodiments, the clamp 404 comprises a first half-shell structure 406 and a second half-shell structure 408. The annular structure 402 is interposed between the first half-shell structure 406 and the second half-shell structure 408. The first half-shell structure 406 comprises a first planar portion 406A, a second planar portion 406C, and a curved portion 406B connecting the first planar portion 406A to the second planar portion 406C. In the illustrated embodiment, the curved portion 406B has an inner radius of 21.39 mm and an outer radius of 24.4 mm, the first planar portion 406A has a length of 18.33 mm, and the second planar portion 406C has a length of 18.33 mm. The first half-shell structure 406 may be formed by shaping a metallic strip. The metallic strip may have a substantially uniform thickness. In the illustrated embodiment, the first half-shell structure 406 has a substantially uniform thickness of 3.01 mm.

The second half-shell structure 408 comprises a first planar portion 408A, a second planar portion 408C, and a curved portion 408B connecting the first planar portion 408A to the second planar portion 408C. In the illustrated embodiment, the curved portion 408B has an inner radius of 21.39 mm and an outer radius of 24.4 mm, the first planar portion 408A has a length of 18.33 mm, and the second planar portion 408C has a length of 18.33 mm. The second half-shell structure 408 may be formed by shaping a metallic strip. The metallic strip may have a substantially uniform thickness. In the illustrated embodiment, the second half-shell structure 408 has a substantially uniform thickness of 3.01 mm.

The first half-shell structure 406 and the second half-shell structure 408 may be secured around the annular structure 402 using a first tightening mechanism 410 and a second tightening mechanism 412. The annular structure 402 is interposed between the first tightening mechanism 410 and the second tightening mechanism 412. In certain embodiments, the first tightening mechanism 410 extends through the first planar portion 406A of the first half-shell structure 406 and the first planar portion 408A of the second half-shell structure 408, and the second tightening mechanism 412 extends through the second planar portion 406C of the first half-shell structure 406 and the second planar portion 408C of the second half-shell structure 408. In the illustrated embodiment, the first planar portion 406A of the first half-shell structure 406 is spaced apart from the first planar portion 408A of the second half-shell structure 408 by a distance of 2.52 mm, and the second planar portion 406C of the first half-shell structure 406 is spaced apart from the second planar portion 408C of the second half-shell structure 408 by a distance of 2.52 mm. Each of the first tightening mechanism 410 and the second tightening mechanism 412 may comprise a screw, a nut and a bolt, or other suitable tightening mechanisms. The first tightening mechanism 410 and the second tightening mechanism 412 may be made of a metallic material, a plastic material, or the like.

In certain embodiments, the annular structure 402 may function both as a spring element and a damping element, and the clamp 404 (including, the first half-shell structure 406, the second half-shell structure 408, the first tightening mechanism 410 and second tightening mechanism 412) may function as a mass element. A mass of a mass element of the mass damper 400, a spring constant of a spring element of the mass damper 400 and a damping constant of a damper element of the mass damper 400 may be determined by performing computer simulations (e.g., finite-element simulations) on the HVAC system 100 (see FIG. 2). For example, the mass of the mass element, the spring constant of the spring element and the damping constant of the damper element may be determined by ensuring that the stress exerted on the refrigerant pipe (e.g., the refrigerant pipe 202 of FIG. 2) during operation or transportation is reduced, which in turn reduces vibrations (e.g., vibration amplitude) in the refrigerant pipe (e.g., the refrigerant pipe 202 of FIG. 2). The mass of the mass element, the spring constant of the spring element and the damping constant of the damper element are used to determine materials and geometry (e.g., dimensions) for the annular structure 402 and the clamp 404 (including, the first half-shell structure 406, the second half-shell structure 408, the first tightening mechanism 410 and second tightening mechanism 412).

FIG. 5 is a schematic diagram of an embodiment of a mass damper 500. The mass damper 500 may comprise an annular structure 502 and a clamp 504. The clamp 504 is configured to secure the annular structure 502 at a desired location (e.g., location 206 of FIG. 2) of the refrigerant pipe 202. The annular structure 502 is made of an elastic material. In certain embodiments, the elastic material may comprise nitrile rubber or the like. The annular structure 502 has a hole 514 and a cut 516 extending from an inner sidewall of the annular structure 502 to an outer sidewall of the annular structure 502. The annular structure 502 is attached to the refrigerant pipe 202 such that the refrigerant pipe 202 extends through the hole 514. The cut 516 of the annular structure 502 is configured to aid in placing the annular structure 502 at the desired location (e.g., location 206 of FIG. 2) of the refrigerant pipe 202. For example, the cut 516 may be expanded to form a gap through which the refrigerant pipe 202 may be inserted into the annular structure 502. In the illustrated embodiment, the annular structure 502 has a shape of a cylindrical shell. In other embodiments, the annular structure 502 may have any desired annular shape depending on technical requirements of the mass damper 500. In certain embodiments, the annular structure 502 is attached to the refrigerant pipe 202 using an adhesive. In such embodiment, an adhesive layer 518 is interposed between the annular structure 502 and the refrigerant pipe 202.

The clamp 504 may be made of a metallic material. The metallic material may comprise copper, aluminum, stainless steel, an alloy thereof, a combination thereof, or the like. In certain embodiments, the clamp 504 comprises a first half-shell structure 506 and a second half-shell structure 508. The annular structure 502 is interposed between the first half-shell structure 506 and the second half-shell structure 508. The first half-shell structure 406 may be formed by machining a metallic block to form a trench therein. A cross-sectional shape of the trench may be chosen such that the annular structure 502 is capable to fit in the trench. In the illustrated embodiment, the first half-shell structure 506 has a non-uniform thickness. The second half-shell structure 508 may be formed by machining a metallic block to form a trench therein. A cross-sectional shape of the trench may be chosen such that the annular structure 502 is capable to fit in the trench. In the illustrated embodiment, the second half-shell structure 508 has a non-uniform thickness.

The first half-shell structure 506 and the second half-shell structure 508 may be secured around the annular structure 502 using a first tightening mechanism 510 and a second tightening mechanism 512. The annular structure 502 is interposed between the first tightening mechanism 510 and the second tightening mechanism 512. Each of the first tightening mechanism 510 and the second tightening mechanism 512 may comprise a screw, a nut and a bolt, or other suitable tightening mechanisms. The first tightening mechanism 510 and the second tightening mechanism 512 may be made of a metallic material, a plastic material, or the like.

In certain embodiments, the annular structure 502 may function both as a spring element and a damping element, and the clamp 504 (including the first half-shell structure 506, the second half-shell structure 508, the first tightening mechanism 510 and second tightening mechanism 512) may function as a mass element. A mass of a mass element of the mass damper 500, a spring constant of a spring element of the mass damper 500 and a damping constant of a damper element of the mass damper 500 may be determined by performing computer simulations (e.g., finite-element simulations) on the HVAC system 100 (see FIG. 1). For example, the mass of the mass element, the spring constant of the spring element and the damping constant of the damper element may be determined by ensuring that the stress exerted on the refrigerant pipe 202 during operation or transportation is reduced, which in turn reduces vibrations (e.g., vibration amplitude) in the refrigerant pipe 202. The mass of the mass element, the spring constant of the spring element and the damping constant of the damper element are used to determine materials and geometry (e.g., dimensions) for the annular structure 502 and the clamp 504 (including the first half-shell structure 506, the second half-shell structure 508, the first tightening mechanism 510 and second tightening mechanism 512).

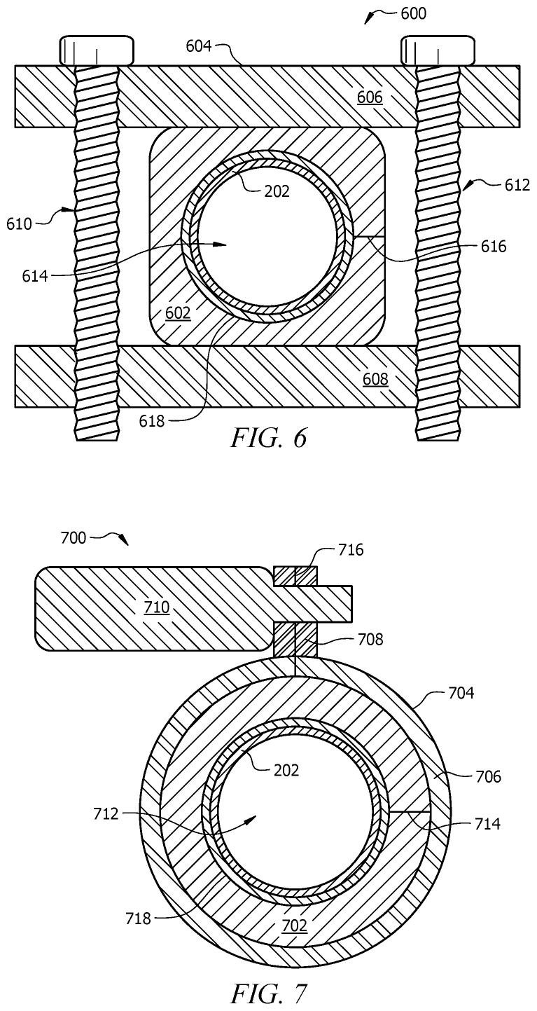

FIG. 6 is a schematic diagram of an embodiment of a mass damper 600. The mass damper 600 may comprise an annular structure 602 and a clamp 604. The clamp 604 is configured to secure the annular structure 602 at a desired location (e.g., location 206 of FIG. 2) of the refrigerant pipe 202. The annular structure 602 is made of an elastic material. In certain embodiments, the elastic material may comprise nitrile rubber or the like. The annular structure 602 has a hole 614 and a cut 616 extending from an inner sidewall of the annular structure 602 to an outer sidewall of the annular structure 602. The annular structure 602 is attached to the refrigerant pipe 202 such that the refrigerant pipe 202 extends through the hole 614. The cut 616 of the annular structure 602 is configured to aid in placing the annular structure 602 at the desired location (e.g., location 206 of FIG. 2) of the refrigerant pipe 202. For example, the cut 616 may be expanded to form a gap through which the refrigerant pipe 202 may be inserted into the annular structure 602. In the illustrated embodiment, the annular structure 602 has an annular shape such that an inner sidewall of the annular shape forms a cylinder, and an outer sidewall of the annular shape forms a right rectangular prism with rounded edges. In other embodiments, the annular structure 602 may have any desired annular shape depending on technical requirements of the mass damper 600. In certain embodiments, the annular structure 602 is attached to the refrigerant pipe 202 using an adhesive. In such embodiment, an adhesive layer 618 is interposed between the annular structure 602 and the refrigerant pipe 202.

The clamp 604 may be made of a metallic material. The metallic material may comprise copper, aluminum, stainless steel, an alloy thereof, a combination thereof, or the like. The clamp 604 comprises a first plate 606 and a second plate 608. In certain embodiments, each of the first plate 606 and the second plate 608 may have a substantially uniform thickness. The annular structure 602 is interposed between the first plate 606 and the second plate 608. The first plate 606 and the second plate 608 are secured around the annular structure 602 using a first tightening mechanism 610 and a second tightening mechanism 612. The annular structure 602 is interposed between the first tightening mechanism 610 and the second tightening mechanism 612. Each of the first tightening mechanism 610 and the second tightening mechanism 612 may comprise a screw, a nut and a bolt, or other suitable tightening mechanisms. The first tightening mechanism 610 and the second tightening mechanism 612 may be made of a metallic material, a plastic material, or the like.

In certain embodiments, the annular structure 602 may function both as a spring element and a damping element, and the clamp 604 (including the first plate 606, the second plate 608, the first tightening mechanism 610 and second tightening mechanism 612) may function as a mass element. A mass of a mass element of the mass damper 600, a spring constant of a spring element of the mass damper 600 and a damping constant of a damper element of the mass damper 600 may be determined by performing computer simulations (e.g., finite-element simulations) on the HVAC system 100 (see FIG. 1). For example, the mass of the mass element, the spring constant of the spring element and the damping constant of the damper element may be determined by ensuring that the stress exerted on the refrigerant pipe 202 during operation or transportation is reduced, which in turn reduces vibrations (e.g., vibration amplitude) in the refrigerant pipe 202. The mass of the mass element, the spring constant of the spring element and the damping constant of the damper element are used to determine materials and geometry (e.g., dimensions) for the annular structure 602 and the clamp 604 (including the first plate 606, the second plate 608, the first tightening mechanism 610 and second tightening mechanism 612).

FIG. 7 is a schematic diagram of an embodiment of a mass damper 700. The mass damper 700 may comprise an annular structure 702 and a clamp 704. The clamp 704 is configured to secure the annular structure 702 at a desired location (e.g., location 206 of FIG. 2) of the refrigerant pipe 202. The annular structure 702 is made of an elastic material. In certain embodiments, the elastic material may comprise nitrile rubber or the like. The annular structure 702 has a hole 712 and a cut 714 extending from an inner sidewall of the annular structure 702 to an outer sidewall of the annular structure 702. The annular structure 702 is attached to the refrigerant pipe 202 such that the refrigerant pipe 202 extends through the hole 712. The cut 714 of the annular structure 702 is configured to aid in placing the annular structure 702 at the desired location (e.g., location 206 of FIG. 2) of the refrigerant pipe 202. For example, the cut 714 may be expanded to form a gap through which the refrigerant pipe 202 may be inserted into the annular structure 702. In the illustrated embodiment, the annular structure 702 has a shape of a cylindrical shell. In other embodiments, the annular structure 702 may have any desired annular shape depending on technical requirements of the mass damper 700. In certain embodiments, the annular structure 702 is attached to the refrigerant pipe 202 using an adhesive. In such embodiment, an adhesive layer 718 is interposed between the annular structure 702 and the refrigerant pipe 202.

The clamp 704 may be made of a metallic material. The metallic material may comprise copper, aluminum, stainless steel, an alloy thereof, a combination thereof, or the like. The clamp 704 comprises an annular structure 706 and a planar structure 708 attached to the annular structure 706. The annular structure 706 surrounds the annular structure 702. The clamp 704 has a cut 716 extending from an inner sidewall of the annular structure 706 to an outer sidewall of the annular structure 706 and through the planar structure 708. The cut 716 of the clamp 704 is configured to aid in placing the clamp 704 around the annular structure 702. For example, the cut 716 may be expanded to form a gap through which the annular structure 702 may be inserted into the annular structure 706.

The clamp 704 is secured around the annular structure 702 using a tightening mechanism 710. The tightening mechanism 710 extends through the planar structure 708 of the clamp 704. The tightening mechanism 710 may comprise a screw, a nut and a bolt, or other suitable tightening mechanisms. The tightening mechanism 710 may be made of a metallic material, a plastic material, or the like. In embodiments when the tightening mechanism 710 comprises a screw, dimensions of a head of the screw may be altered to alter a mass of the tightening mechanism 710 and in turn a mass of the clamp 704. In the illustrated embodiment, the annular structure 706 has a shape of a cylindrical shell. In other embodiments, the annular structure 706 may have any desired annular shape depending on technical requirements of the mass damper 700.

In certain embodiments, the annular structure 702 may function both as a spring element and a damping element, and the clamp 704 (including the annular structure 706, the planar structure 708 and the tightening mechanism 710) may function as a mass element. A mass of a mass element of the mass damper 700, a spring constant of a spring element of the mass damper 700 and a damping constant of a damper element of the mass damper 700 may be determined by performing computer simulations (e.g., finite-element simulations) on the HVAC system 100 (see FIG. 1). For example, the mass of the mass element, the spring constant of the spring element and the damping constant of the damper element may be determined by ensuring that the stress exerted on the refrigerant pipe 202 during operation or transportation is reduced, which in turn reduces vibrations (e.g., vibration amplitude) in the refrigerant pipe 202. The mass of the mass element, the spring constant of the spring element and the damping constant of the damper element are used to determine materials and geometry (e.g., dimensions) for the annular structure 702 and the clamp 704 (including the annular structure 706, the planar structure 708 and the tightening mechanism 710).

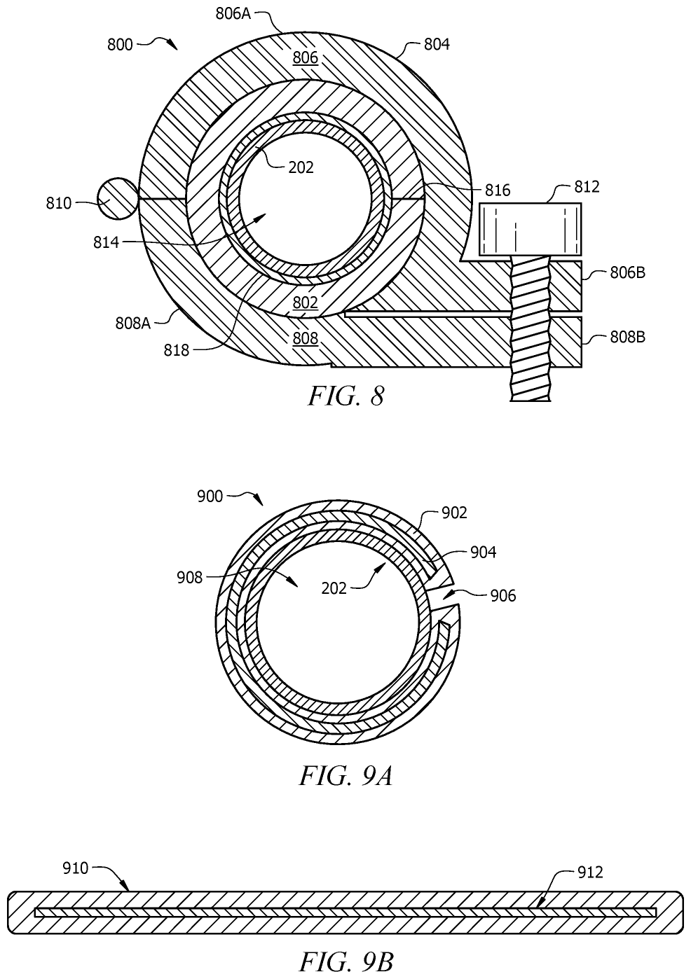

FIG. 8 is a schematic diagram of an embodiment of a mass damper 800. The mass damper 800 may comprise an annular structure 802 and a clamp 804. The clamp 804 is configured to secure the annular structure 802 at a desired location (e.g., location 206 of FIG. 2) of the refrigerant pipe 202. The annular structure 802 is made of an elastic material. In certain embodiments, the elastic material may comprise nitrile rubber or the like. The annular structure 802 has a hole 814 and a cut 816 extending from an inner sidewall of the annular structure 802 to an outer sidewall of the annular structure 802. The annular structure 802 is attached to the refrigerant pipe 202 such that the refrigerant pipe 202 extends through the hole 814. The cut 816 of the annular structure 802 is configured to aid in placing the annular structure 802 at the desired location (e.g., location 206 of FIG. 2) of the refrigerant pipe 202. For example, the cut 816 may be expanded to form a gap through which the refrigerant pipe 202 may be inserted into the annular structure 802. In the illustrated embodiment, the annular structure 802 has a shape of a cylindrical shell. In other embodiments, the annular structure 802 may have any desired annular shape depending on technical requirements of the mass damper 800. In certain embodiments, the annular structure 802 is attached to the refrigerant pipe 202 using an adhesive. In such embodiment, an adhesive layer 818 is interposed between the annular structure 802 and the refrigerant pipe 202.

The clamp 804 may be made of a metallic material. The metallic material may comprise copper, aluminum, stainless steel, an alloy thereof, a combination thereof, or the like. The clamp 804 comprises a first half-shell structure 806 and a second half-shell structure 808. The first half-shell structure 806 comprises a curved portion 806A and a planar portion 806B attached to the curved portion 806A. The second half-shell structure 808 comprises a curved portion 806A and a planar portion 808B attached to the curved portion 808A. In certain embodiments, each of the first half-shell structure 806 and the second half-shell structure 808 may have a substantially uniform thickness. Each of the first half-shell structure 806 and the second half-shell structure 808 may be formed by shaping a metallic strip. The metallic strip may have a uniform thickness. The first half-shell structure 806 is attached to the second half-shell structure 808 using a hinge 810. The hinge 810 is configured to aid the clamp 804 in placing the clamp 804 around the annular structure 802. The clamp 804 is secured around the annular structure 802 using a tightening mechanism 812. The tightening mechanism 812 extends through the planar portions 806B and 808B of the first half-shell structure 806 and the second half-shell structure 808, respectively. The tightening mechanism 812 may comprise a screw, a nut and a bolt, or other suitable tightening mechanisms. The tightening mechanism 812 may be made of a metallic material, a plastic material, or the like.

In certain embodiments, the annular structure 802 may function both as a spring element and a damping element, and the clamp 804 (including the first half-shell structure 806, the second half-shell structure 808, the hinge 810 and the tightening mechanism 812) may function as a mass element. A mass of a mass element of the mass damper 800, a spring constant of a spring element of the mass damper 800 and a damping constant of a damper element of the mass damper 800 may be determined by performing computer simulations (e.g., finite-element simulations) on the HVAC system 100 (see FIG. 1). For example, the mass of the mass element, the spring constant of the spring element and the damping constant of the damper element may be determined by ensuring that the stress exerted on the refrigerant pipe 202 during operation or transportation is reduced, which in turn reduces vibrations (e.g., vibration amplitude) in the refrigerant pipe 202. The mass of the mass element, the spring constant of the spring element and the damping constant of the damper element are used to determine materials and geometry (e.g., dimensions) for the annular structure 802 and the clamp 804 (including the first half-shell structure 806, the second half-shell structure 808, the hinge 810 and the tightening mechanism 812).

FIG. 9A is a schematic diagram of an embodiment of a mass damper 900. The mass damper 900 comprises an annular structure 904 embedded in an annular structure 902. The annular structure 902 may be made of an elastic material. In certain embodiments, the elastic material may comprise nitrile rubber or the like. The annular structure 904 may be made of a metallic material. The metallic material may comprise copper, aluminum, stainless steel, an alloy thereof, a combination thereof, or the like. The annular structure 902 has a hole 908. The annular structure 902 is attached to the refrigerant pipe 202 such that the refrigerant pipe 202 extends through the hole 908. In the illustrated embodiment, the mass damper 900 has a shape of a cylindrical shell. In other embodiments, the mass damper 900 may have any desired annular shape depending on technical requirements of the mass damper 900. The mass damper 900 has a cut 906 extending from an inner sidewall of the mass damper 900 to an outer sidewall of the mass damper 900. The cut 906 extends through the annular structures 902 and 904. In certain embodiments, the mass damper 900 may be formed by embedding a metallic strip 912 in an elastic strip 910 as illustrated in FIG. 9B. The elastic strip 910 with embedded metallic strip 912 may be snapped around the refrigerant pipe 202 to place and secure the mass damper 900 at the desired location (e.g., location 206 of FIG. 2) of the refrigerant pipe 202.

In certain embodiments, the annular structure 902 may function both as a spring element and a damping element, and the annular structure 905 may function as the spring element and a mass element. A mass of a mass element of the mass damper 900, a spring constant of a spring element of the mass damper 900 and a damping constant of a damper element of the mass damper 900 may be determined by performing computer simulations (e.g., finite-element simulations) on the HVAC system 100 (see FIG. 1). For example, the mass of the mass element, the spring constant of the spring element and the damping constant of the damper element may be determined by ensuring that the stress exerted on the refrigerant pipe 202 during operation or transportation is reduced, which in turn reduces vibrations (e.g., vibration amplitude) in the refrigerant pipe 202. The mass of the mass element, the spring constant of the spring element and the damping constant of the damper element are used to determine materials and geometry (e.g., dimensions) for the annular structures 902 and 904.

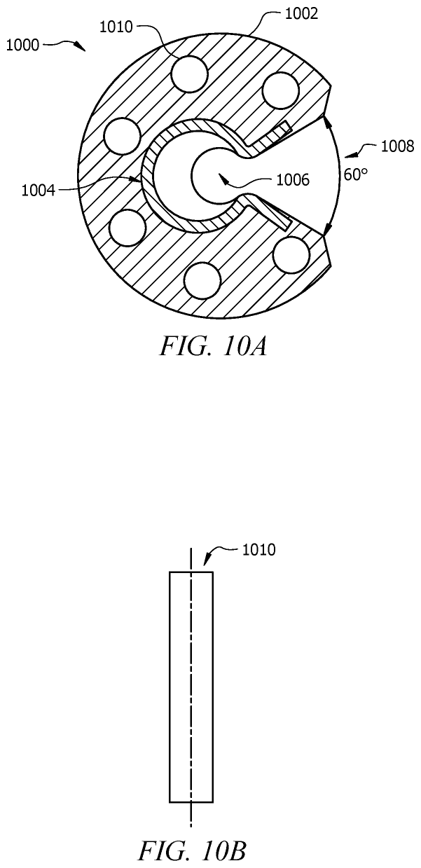

FIG. 10A is a schematic diagram of an embodiment of a mass damper 1000. The mass damper 1000 comprises an annular structure 1004 embedded in an annular structure 1002. The annular structure 1002 may be made of an elastic material. In certain embodiments, the elastic material may comprise nitrile rubber or the like. The annular structure 1004 may be made of a metallic material. The metallic material may comprise copper, aluminum, stainless steel, an alloy thereof, a combination thereof, or the like. The annular structure 1002 has a hole 1006. The annular structure 1002 is attached to the refrigerant pipe 202 such that the refrigerant pipe 202 extends through the hole 1006. The annular structure 1002 has a cut 1008 extending from an inner sidewall of the annular structure 1002 to an outer sidewall of the annular structure 1002. In certain embodiments, portions of the annular structure 1004 may be exposed by the cut 1008. In the illustrated embodiment, the cut 1008 has a shape of a circular sector having an angle of 60 degrees. In other embodiments, the cut 1008 may have any desired shape depending on technical requirements of the mass damper 1000.

In certain embodiments, the mass damper 1000 may further comprise one or more pins 1010 embedded in the annular structure 1002. FIG. 10B illustrates a schematic diagram of a pin 1010. The one or more pins 1010 may be made of a metallic material. The metallic material may comprise copper, aluminum, stainless steel, an alloy thereof, a combination thereof, or the like. The one or more pins 1010 may have cylindrical shapes. In the illustrated embodiment, 6 pins 1010 are embedded in the annular structure 1002. In other embodiments, the number of pins 1010 may be any desired value depending on technical requirements of the mass damper 1000. For example, the number of pins 1010 may be altered to tune a mass of the mass damper 1000.

In certain embodiments, the annular structure 1002 may function both as a spring element and a damping element, the annular structure 1004 may function as the spring element, and the one or more pins 1010 may function as a mass element. A mass of a mass element of the mass damper 1000, a spring constant of a spring element of the mass damper 1000 and a damping constant of a damper element of the mass damper 1000 may be determined by performing computer simulations (e.g., finite-element simulations) on the HVAC system 100 (see FIG. 1). For example, the mass of the mass element, the spring constant of the spring element and the damping constant of the damper element may be determined by ensuring that the stress exerted on the refrigerant pipe 202 during operation or transportation is reduced, which in turn reduces vibrations (e.g., vibrations amplitude) in the refrigerant pipe 202. The mass of the mass element, the spring constant of the spring element and the damping constant of the damper element are used to determine materials and geometry (e.g., dimensions) for the annular structures 1002 and 1004, and the one or more pins 1010.

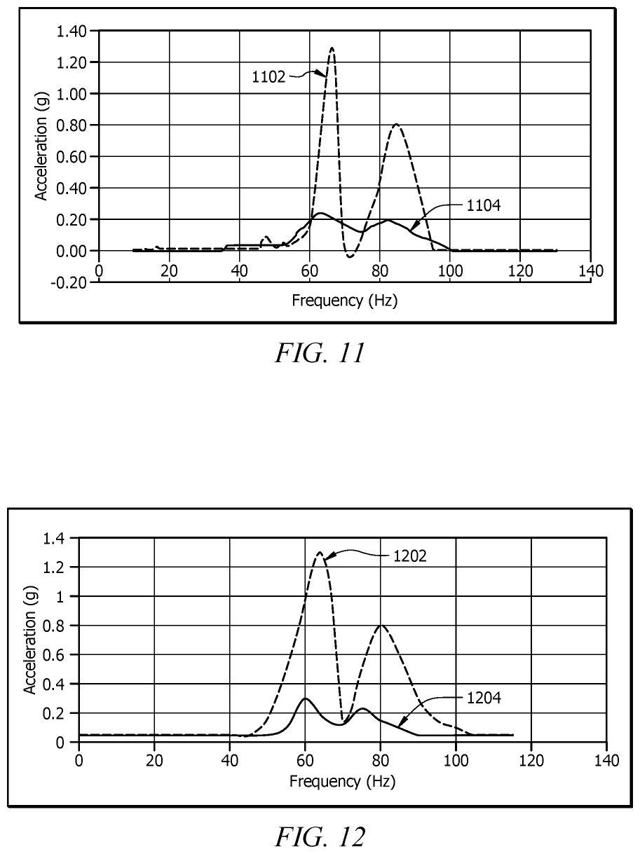

FIG. 11 illustrates graphs 1102 and 1104 of a simulated acceleration of a refrigerant pipe (e.g., refrigerant pipe 202 of FIG. 2) with or without an attached mass damper (e.g., any of mass dampers 400, 500, 600, 700, 800, 900 and 1000 of FIGS. 4 through 8, 9A, and 10A, respectively). In certain embodiments, in-operation behavior of the HVAC system 100 (see FIG. 1) may be simulated using a finite-element simulation to determine an acceleration of a refrigerant pipe with or without the attached mass damper. The simulation results are used to determine a mass of a mass element, a spring constant of a spring element, a damping constant of a damping element of the mass damper, which reduce an acceleration (or a vibration amplitude) of the refrigerant pipe.

The graph 1102 illustrates a simulated acceleration (in the units of Earth's gravitation acceleration g) as a function of frequency (in the units of Hz) for a refrigerant pipe without an attached mass damper. In the illustrated embodiment, the refrigerant pipe has a natural (i.e., resonant) frequency of 65 Hz.

The graph 1104 illustrates a simulated acceleration (in the units of Earth's gravitation acceleration g) as a function of frequency (in the units of Hz) for a refrigerant pipe with an attached mass damper. In the illustrated embodiment, a simulated acceleration of the refrigerant pipe at the natural (i.e., resonant) frequency of 65 Hz is reduced by more than 85% compared to the graph 1102. Furthermore, simulated accelerations of the refrigerant pipe at frequencies different from the natural frequency are also reduced compared to the graph 1102. The mass of the mass element, the spring constant of the spring element, and the damping constant of the damping element are used to determine materials and geometry (e.g., dimensions) of various components of the mass damper.

FIG. 12 illustrates graphs of measured acceleration of a refrigerant pipe (e.g., refrigerant pipe 202 of FIG. 2) with or without an attached mass damper (e.g., any of mass dampers 400, 500, 600, 700, 800, 900 and 1000 of FIGS. 4 through 8, 9A, and 10A, respectively). In certain embodiments, an acceleration of a refrigerant pipe is measured while operating the HVAC system 100 (see FIG. 1). In other embodiments, an acceleration of a refrigerant pipe is measured while inducing vibrations in the refrigerant pipe using a shaker.

The graph 1202 illustrates a measured acceleration (in the units of Earth's gravitation acceleration g) as a function of frequency (in the units of Hz) for a refrigerant pipe without an attached mass damper. In the illustrated embodiment, the refrigerant pipe has a natural (i.e., resonant) frequency of 65 Hz.

The graph 1204 illustrates a measured acceleration (in the units of Earth's gravitation acceleration g) as a function of frequency (in the units of Hz) for a refrigerant pipe with an attached mass damper. In the illustrated embodiment, the measured acceleration of the refrigerant pipe at the natural frequency is reduced by more than 85% compared to the graph 1202. Furthermore, measured accelerations of the refrigerant pipe at frequencies different from the natural frequency are also reduced compared to the graph 1202. In addition, by using a mass damper, a stress exerted on the refrigerant pipe that is caused by the vibrations in the refrigerant pipe is also reduced by 85% compared to when no mass damper is used. The graphs 1202 and 1204 show a good agreement with the graphs 1102 and 1104 (see FIG. 11), respectively.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A damper attached to a refrigerant pipe of a heating, ventilation, and air conditioning (HVAC) system at a first location, the damper comprising:
a first annular structure comprising an elastic material, wherein the refrigerant pipe extends through the first annular structure; and
a clamp configured to secure the first annular structure at the first location of the refrigerant pipe, wherein the clamp comprises:
a metallic material; and
one or more tightening mechanisms configured to secure the clamp at the first location of the refrigerant pipe.

2. The damper of claim 1, wherein:
the refrigerant pipe has a first vibration amplitude at the first location for a first natural frequency; and
the damper has a mass, a spring constant, and a damping constant such that the damper reduces the first vibration amplitude of the refrigerant pipe during operation or transportation.

3. The damper of claim 1, wherein the clamp further comprises:
a first half-shell structure; and
a second half-shell structure attached to the first half-shell structure using a first tightening mechanism and a second tightening mechanism, wherein:
the first annular structure is interposed between the first half-shell structure and the second half-shell structure; and
the first annular structure is interposed between the first tightening mechanism and the second tightening mechanism.

4. The damper of claim 3, wherein each of the first half-shell structure and the second half-shell structure has a substantially uniform thickness.

5. The damper of claim 3, wherein each of the first half-shell structure and the second half-shell structure has a non-uniform thickness.

6. The damper of claim 1, further comprising an adhesive layer between the first annular structure and the refrigerant pipe.

7. The damper of claim 1, wherein the elastic material comprises nitrile rubber.

8. A damper attached to a refrigerant pipe of a heating, ventilation, and air conditioning (HVAC) system at a first location, the damper comprising:
a first annular structure comprising:
an elastic material having:
a hole therein, wherein the refrigerant pipe extends through the hole; and
a cut extending from an inner sidewall of the elastic material to an outer sidewall of the elastic material; and
a clamp configured to secure the first annular structure at the first location of the refrigerant pipe, wherein the clamp comprises:
a metallic material; and
one or more tightening mechanisms configured to secure the clamp at the first location of the refrigerant pipe.

9. The damper of claim 8, wherein the damper has a mass, a spring constant, and a damping constant such that the damper reduces a stress exerted on the refrigerant pipe during operation or transportation.

10. The damper of claim 8, wherein the clamp further comprises:
a first plate; and
a second plate attached to the first plate using a first tightening mechanism and a second tightening mechanism, wherein:
the first annular structure is interposed between the first plate and the second plate; and
the first annular structure is interposed between a first tightening mechanism and a second tightening mechanism.

11. The damper of claim 8, wherein the clamp further comprises a second annular structure surrounding the first annular structure, wherein:
the second annular structure is secured to the first annular structure using a first tightening mechanism;
the second annular structure has a second cut extending from an inner sidewall of the second annular structure to an outer sidewall of the second annular structure; and
the first tightening mechanism provides the clamp with a desired mass.

12. The damper of claim 8, wherein the clamp further comprises:
a first half-shell structure; and
a second half-shell structure attached to the first half-shell structure using a hinge, wherein:
a first tightening mechanism secures the first half-shell structure and the second half-shell structure around the first annular structure; and
the refrigerant pipe is interposed between the hinge and the first tightening mechanism.

13. The damper of claim 8, wherein the first annular structure has a shape of a cylindrical shell.

14. The damper of claim 8, further comprising an adhesive layer between the first annular structure and the refrigerant pipe.

15. A damper attached to a refrigerant pipe of a heating, ventilation, and air conditioning (HVAC) system, the damper comprising:
an annular elastic structure, wherein the refrigerant pipe extends through the annular elastic structure; and
an annular metallic structure embedded in the annular elastic structure.

16. The damper of claim 15, further comprising one or more metallic pins embedded in the annular elastic structure.

17. The damper of claim 16, wherein the one or more metallic pins have a shape of a cylinder.

18. The damper of claim 15, wherein the annular elastic structure has a cut extending from an inner sidewall of the annular elastic structure to an outer sidewall of the annular elastic structure.

19. The damper of claim 15, further comprising an adhesive layer between the annular elastic structure and the refrigerant pipe.

20. The damper of claim 15, wherein the damper has a mass, a spring constant, and a damping constant such that the damper reduces vibrations in the refrigerant pipe caused by a compressor of the HVAC system during operation.
